(19) United States
(12) Patent Application Publication
(10) Pub. No.: US 2023/0287839 A1
(43) Pub. Date: Sep. 14, 2023

(54) MITIGATION OF POWERTRAIN AND ACCESSORY TORSIONAL OSCILLATION THROUGH ELECTRIC MOTOR/GENERATOR CONTROL

(71) Applicant: Tula Technology, Inc., San Jose, CA (US)

(72) Inventors: John W. PARSELS, San Jose, CA (US); Matthew A. YOUNKINS, Campbell, CA (US)

(21) Appl. No.: 18/317,812

(22) Filed: May 15, 2023

Related U.S. Application Data
(63) Continuation of application No. 17/190,873, filed on Mar. 3, 2021.
Application No. 17/190,873 is a continuation-in-part of application No. 17/064,354, filed on Oct. 6, 2020, now Pat. No. 11,136,928.
Application No. 17/064,354 is a continuation of application No. 16/246,888, filed on Jan. 14, 2019, now Pat. No. 10,830,166.
Application No. 16/246,888 is a continuation of application No. 15/340,291, filed on Nov. 1, 2016, now Pat. No. 10,221,786.
Application No. 15/340,291 is a continuation of application No. 14/992,779, filed on Jan. 11, 2016, now Pat. No. 9,512,794.
Application No. 17/190,873 is a continuation-in-part of application No. 16/283,404, filed on Feb. 22, 2019, now abandoned.
(60) Provisional application No. 62/102,206, filed on Jan. 12, 2015.
(60) Provisional application No. 62/137,539, filed on Mar. 24, 2015.
(60) Provisional application No. 62/635,656, filed on Feb. 27, 2018.

(51) Int. Cl. F02D 41/00; F02D 41/14; F02D 41/30; B60W 30/20

(52) U.S. Cl. CPC F02D 41/0087; F02D 41/1498; F02D 41/307; B60W 30/20; F02D 41/0002; F02D 41/3058; F02D 2041/0012

(57) ABSTRACT

A variety of methods and arrangements for mitigating powertrain and accessory torsional oscillation through electric motor/generator control are described. In one aspect, working chamber air charge and crank position are determined prior to starting an engine. During the engine startup period, an electric motor/generator supplies a smoothing torque to at least partially cancel engine torque variations.

### CROSS-REFERENCE TO RELATED APPLICATIONS

This application is a Continuation of U.S. application Ser. No. 17/190,873, filed Mar. 3, 2021 (P069X1), which is a Continuation-in-Part of U.S. application Ser. No. 17/064,354 (P046C3), filed on Oct. 6, 2020 (now U.S. Pat. No. 11,136,928, issued Oct. 5, 2021), which is a Continuation of U.S. application Ser. No. 16/246,888 (P046C2) filed on Jan. 14, 2019 (now U.S. Pat. No. 10,830,166, issued on Nov. 10, 2020), which is a Continuation of U.S. application Ser. No. 15/340,291 (P046C1), filed Nov. 1, 2016 (now U.S. Pat. No. 10,221,786, issued on Mar. 5, 2019), which is a Continuation of U.S. application Ser. No. 14/992,779 (P046), filed on Jan. 11, 2016 (now U.S. Pat. No. 9,512,794, issued Dec. 6, 2016), which claims priority of U.S. Provisional Patent Application Nos. 62/102,206 (P046P), filed on Jan. 12, 2015 and 62/137,539 (P046P2), filed on Mar. 24, 2015. Each of the foregoing priority applications is incorporated herein by reference in its entirety.

U.S. application Ser. No. 17/190,873 is also a Continuation-in-Part of U.S. application Ser. No. 16/283,404 (P069), filed on Feb. 22, 2019 which claims priority of U.S. Provisional Application No. 62/635,656 (P069P), filed on Feb. 27, 2018. All of the foregoing priority applications are incorporated herein by reference in their entirety.

### FIELD OF THE INVENTION

The present invention relates to control of an internal combustion engine having a hybrid powertrain. More specifically, the present invention relates to mitigation of powertrain and accessory torsional oscillation through electric motor/generator control during an engine stop/start cycle.

### BACKGROUND

There are various ongoing efforts to improve the fuel efficiency of internal combustion engines. One approach involves a start/stop feature, which is implemented in an increasing number of vehicles. In a conventional vehicle, when a vehicle comes to a stop (e.g., at a traffic light or stop sign), the internal combustion engine continues to run at an idle speed, which consumes fuel. In vehicles equipped with a start/stop feature, when the vehicle comes to a stop and other selected conditions are satisfied, the internal combustion engine automatically shuts down to conserve fuel. When a driver releases the brake pedal and/or activates the accelerator pedal, the engine restarts. There may be other selected conditions that can trigger an engine restart.

Some vehicles with a start/stop feature utilize an electric motor/generator. That is, the electric motor/generator is capable of subtracting torque from the engine to charge a battery by converting the engine's mechanical energy into electrical energy. The motor/generator is also capable of converting battery electrical energy into mechanical energy, which can be used to help restart the engine in a start/stop system. The motor/generator is typically integrated with a crankshaft or mechanically coupled to rotation of the crankshaft via a belt, chain, or gear drive system. A belt alternator starter system with a motor/generator is one example of such a system.

In addition to using a start/stop system, other powertrain designs and control methods have been used to improve the fuel efficiency of internal combustion engines. One technique is having a small number of engine working chambers, for example, to 2, 3, or 4 cylinders. Another technique to improve fuel efficiency is varying the effective engine displacement. This allows for the full torque to be available when required, yet can significantly reduce pumping losses and improve thermal efficiency by using a smaller displacement when full torque is not required. The most common method today of implementing a variable displacement engine is to deactivate a group of cylinders substantially simultaneously. In this approach the intake and exhaust valves associated with the deactivated cylinders are kept closed and no fuel is injected when it is desired to skip a combustion event. For example, an 8 cylinder variable displacement engine may deactivate half of the cylinders (i.e. 4 cylinders) so that it is operating using only the remaining 4 cylinders. Commercially available variable displacement engines available today typically support only two or at most three displacements.

Another engine control approach that varies the effective displacement of an engine is referred to as “skip-fire” engine control. In general, skip-fire engine control contemplates selectively skipping the firing of certain cylinders during selected firing opportunities. Thus, a particular cylinder may be fired during one engine cycle and then may be skipped during the next engine cycle and then selectively skipped or fired during the next. From an engine cycle perspective, this means that sequential engine cycles may have different patterns of skipped and fired cylinders. In this manner, even finer control of the effective engine displacement is possible. For example, firing every third cylinder in a 4 cylinder engine would provide an effective displacement of ⅓^{rd} of the full engine displacement, which is a fractional displacement that is not obtainable by simply deactivating a set of cylinders.

A problem with low-cylinder-count engines, variable displacement engines, or skip fire controlled engines is that the frequency of combustion events is lower than in continuously-firing, high-cylinder-count engines. Thus, the engine torque output is not as smooth and the resultant NVH (noise, vibration, and harshness) may be unacceptable to vehicle occupants. These NVH issues may be addressed by a variety of means. One approach to reducing NVH is to incorporate one or more vibration absorbing elements in the powertrain, such as a dual mass flywheel, a spring mass vibration absorber, and/or a centrifugal pendulum absorber. Another approach, applicable to vehicles with a hybrid powertrain, is to apply a mitigating or smoothing torque from a motor/generator than cancels or partially cancels engine produced torque oscillations. Such an approach is described in U.S. Pat. Nos. 9,512,794 and 10,060,368, which are incorporated herein by reference.

A problem that arises in a start/stop system is that during a period when the engine is stopped, the pressure within the engine intake manifold and engine cylinders equilibrates with atmospheric pressure. Thus, the cylinder air charge is large and the resultant torque pulse produced by cylinder combustion may be large, which may result in a start cycle with unacceptably high NVH. These NVH issues may be particularly pronounced in engines having a small number of cylinders or engines operating with reduced displacement. Additionally, powertrain elements installed to reduce NVH may excessively oscillate and “bottom out” or “hammer” with the low engine speeds and potentially high torque pulses associated with start-up. These large torque pulses can be mitigated by operating the engine less efficiently, such as by retarding spark timing; however, such measures reduce fuel economy. There is a need to improve fuel economy and NVH characteristics of a hybrid powertrain during start/stop operation.

### SUMMARY OF THE INVENTION

A variety of methods and arrangements for implementing a start/stop feature in a hybrid powertrain are described. In one aspect, the implementation of the start/stop feature involves automatically turning off an internal combustion engine under selected circumstances. A determination is made as to whether the engine should be restarted. During an engine startup period, a motor/generator supplies much or all of the torque necessary to accelerate the engine to idle speeds. The motor/generator works in concert with the internal combustion engine to deliver a smooth torque profile to the powertrain, resulting in prompt restart and acceptable NVH.

When an engine is shut off due to implementation of a start/stop feature, the intake manifold pressure tends to equalize with atmospheric pressure. Thus, when the engine is restarted the firing of one or more working chambers may produce a torque surge resulting in unacceptable NVH that is noticeable to vehicle occupants. The engine induced torque surge is smoothed or at least partially cancelled by application of a smoothing torque from the motor/generator.

In some embodiments, a method and control system for implementing a start/stop feature in a hybrid vehicle powertrain are described. The hybrid vehicle powertrain includes an internal combustion engine having a plurality of working chambers and an electric motor/generator connected with a crankshaft. A stop/start feature is implemented by automatically turning off the engine under selected circumstances during a drive cycle. A determination to restart the engine is made and prior to engine restart a crankshaft rotation angle is determined. An air charge for each working chamber is estimated. Based on the crankshaft rotation angle and air charge a torque profile for each working chamber is determined. The torque profiles for each working chamber are summed to determine the engine torque profile. The electric motor/generator is used to rotationally accelerate the crankshaft and to apply a smoothing torque to the crankshaft, wherein the smoothing torque is arranged to at least partially cancel out a variation in the engine torque profile, thereby reducing NVH that would otherwise be generated by the engine. The engine restart is terminated when the crankshaft rotation speed reaches a level appropriate for normal engine operation.

In other embodiments, a hybrid powertrain system for a vehicle includes an internal combustion engine having a plurality of working chambers connected to a crankshaft and an electric motor/generator mechanically connected to the crankshaft with a belt so that the internal combustion engine and electric motor/generator rotate together. A vibration absorber is connected to and rotates with the crankshaft. A restart coordinator controls the internal combustion engine and the electric/motor generator during an engine restart such that the crankshaft rotation trajectory during the engine restart is sufficiently smooth that it does not result in hammering of the vibration absorber.

Various implementations include a hybrid powertrain controller, software or systems arranged to perform some or all of the above operations.

### BRIEF DESCRIPTION OF THE DRAWINGS

The invention and the advantages thereof, may best be understood by reference to the following description taken in conjunction with the accompanying drawings in which:

FIG. 1 is a block diagram of a hybrid powertrain according to an embodiment of the present invention.

FIG. 2 is a schematic diagram of an electric motor/generator mechanically connected to a crankshaft thru a belt according to an embodiment of the present invention.

FIG. 3 is a schematic diagram of a hybrid powertrain according to an embodiment of the present invention.

FIG. 4 is a schematic diagram of a hybrid powertrain having cylinder deactivation capability according to an embodiment of the present invention.

FIG. 5 is a plot showing representative torque profiles associated with different types of working chamber operation according to an embodiment of the present invention.

FIG. 6 is a plot showing an exemplary engine speed trajectory and crankshaft rotation angle versus time during an engine restart to idle according to an embodiment of the present invention.

FIG. 7 is a plot showing an exemplary engine speed trajectory and crankshaft rotation angle versus time during an aggressive engine restart according to an embodiment of the present invention.

FIG. 8 shows an exemplary engine torque profile during an aggressive engine restart according to an embodiment of the present invention.

FIG. 9 shows an exemplary electric motor/generator torque profile during an aggressive engine restart according to an embodiment of the present invention.

FIG. 10 is a flow chart showing a method for implementing a stop/start system in a hybrid powertrain according to an embodiment of the present invention.

In the drawings, like reference numerals are sometimes used to designate like structural elements. It should also be appreciated that the depictions in the figures are diagrammatic and not to scale.

### DETAILED DESCRIPTION

Start/stop systems have become increasingly prevalent in automobiles and other types of vehicles. A start/stop system involves automatically turning off an engine when selected conditions are met during a drive cycle. A drive cycle is initiated by a key action and terminated by a key action. Within a drive cycle the engine may automatically stop and restart many times. For example, an engine might be automatically turned off when the vehicle comes to a halt at a red light or stop sign in the middle of a drive cycle. The engine is then typically restarted when a driver requests torque by depressing an accelerator pedal, releasing a brake pedal, and/or shifting transmission gears (i.e. forward to reverse or vice versa). The engine may be restarted by a non-driver activated trigger, such insufficient brake vacuum boost or insufficient charge in a battery. Turning off the engine when it is not needed improves fuel efficiency relative to a conventional engine, which continues to run even when it is not needed, for example, idling during vehicle stops. Additionally, in certain cases the internal combustions engine may be stopped and restarted while the vehicle is in motion.

One challenge involved in a start/stop system arises when the engine is restarted. While the engine is turned off, the pressure within an enclosed cylinder volume and intake manifold pressure tend to equalize with atmospheric pressure. As a result, when the engine is restarted, a large amount of air is either already in one or more cylinders or is delivered into the cylinders as the engine spins up. In a conventional engine, that fires all of its working chambers during each engine cycle, this can lead to an undesirable engine speed and/or torque “surge,” which can be perceived by vehicle occupants as unacceptable NVH. These torque surges associated with cylinder firing may result in hammering of a vibration absorber located in the powertrain. One known method to reduce this torque surge in a spark ignition engine is to retard spark timing. While this maintains combustion stability and reduces the torque surge, it wastes fuel, since the combustion energy is inefficiently generating torque.

Another challenge in a stop/start system is to have the engine quickly reach idle speed. Ideally the engine turn-on should be unperceivable to a driver or vehicle occupants. Thus, the engine should reach idle speeds, 600 to 800 rpm, in the time it takes for the driver to remove her/his foot from a brake pedal and begin to depress an accelerator pedal. A representative time for the driver to complete this motion may be approximately 0.5 second.

The present invention uses control of an electric motor/generator in a hybrid powertrain to help reduce or eliminate engine speed surges, thus allowing for a smoother start/stop transition. In general, the motor/generator may supply all or most of the power necessary for the engine to transition from stopped to an idle speed. A smoothing torque may be applied that cancels or partially cancels engine produced torque fluctuations. The torque profile is controlled to provide acceptable NVH characteristics. In particular, a crankshaft rotation trajectory from the applied torque does not “bottom out” or “hammer” any vibration absorbing elements in the powertrain. In some embodiments, the internal combustion engine may use skip fire control, so that some cylinders may be deactivated while the engine is spinning during a stop/start cycle.

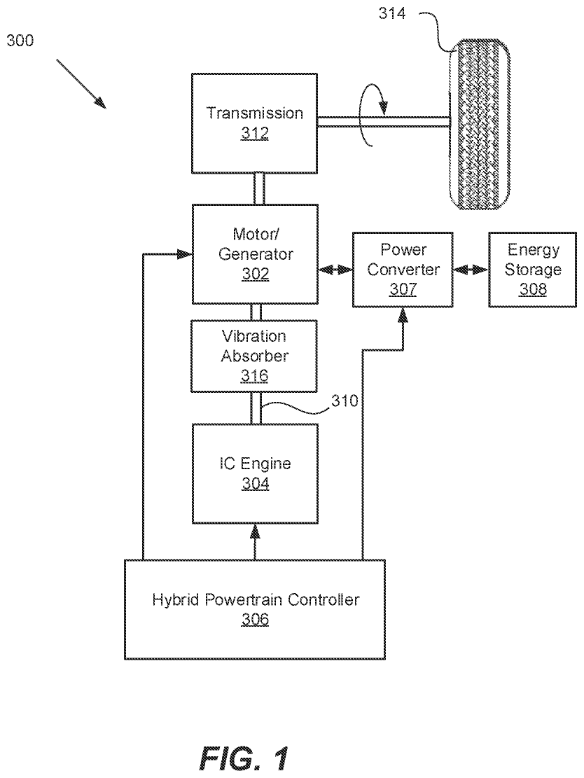

Referring first to FIG. 1, a hybrid powertrain system 300 according to an embodiment of the present invention will be described. The hybrid powertrain system 300 provides motive force to power a vehicle. The hybrid powertrain system 300 includes a hybrid powertrain controller 306, an internal combustion engine 304, an electric motor/generator 302, a power converter 307, an energy storage system 308, a crankshaft 310, a transmission 312, and a wheel 314. The engine 304 and/or the motor/generator 302 are arranged to apply torque to the crankshaft 310, which drives the wheels 314 through the transmission 312. The hybrid powertrain controller 306 is arranged to coordinate the operation of the engine 304 and the motor/generator 302. Some of the various elements shown in FIG. 1 may optionally include an integrated controller (not shown in FIG. 1).

The internal combustion engine 304 may be a four-stroke, spark ignition, gasoline fueled engine. The engine 304 may have a plurality of working chambers, such as 2, 3, 4, 6, 8, 10 or 12, working chamber. Here working chamber refers generally to a combustion chamber, which may be a cylinder or some other enclosed volume surrounding a combustion region. The terms working chamber and cylinder will be used interchangeably when describing the invention. Air is inducted into a cylinder from an intake manifold through one or more intake valves. Air flow into the intake manifold may be controlled by opening and closing a throttle. Opening and closing of the intake valves may be controlled by a cam rotating on a cam shaft. A cam phaser may be used to control intake valve opening and closing timing relative to a crankshaft. Fuel is introduced into the cylinder by either port or preferably direct fuel injection. Combustion of the fuel generates an increase in pressure in the enclosed cylinder volume, which drives a piston causing rotation of the crankshaft. Combustion exhaust is vented from the cylinder through one or more exhaust valves. The exhaust valves may also be controlled by a cam and may have a cam phaser to control the timing of the exhaust valve lift. Exhaust is vented into an exhaust system. The exhaust system will generally have a catalytic converter with a 3-way catalyst, which both oxidizes and reduces pollutants in the exhaust. To be effective, the catalyst must be held at an elevated temperature and the gas pumped through the catalyst must have little or no excess oxygen so that an oxidation/reduction balance may be maintained in the catalyst. This condition may be satisfied by operating the engine with a stoichiometric ratio of fuel to air, so that complete combustion consumes all fuel and oxygen.

The engine 304 may have valve deactivation capabilities so that one or more cylinders may have their intake valve(s) and/or exhaust valve(s) deactivated so that no air is pumped through the cylinder when it is deactivated. Depending on the engine design, all cylinders may be capable of deactivation or only a limited number may configured for deactivation. Valve deactivation is an essential part of skip-fire control in exhaust systems using a 3-way catalyst. Without valve deactivation excess oxygen would flow through the catalyst from deactivated cylinders and saturate the catalyst causing it to lose its ability to reduce pollutants in the exhaust. The valves may be deactivated by controlling oil pressure in a collapsible valve lifter. When the lifter is in its collapsible state, motion of a cam follower is not transmitted to the valve and the cylinder is deactivated. With the lifter rigid, the cam profile is transmitted to the valve causing it to open and close, activating the cylinder. The deactivation system can be functional at low engine speeds by using an auxiliary oil pump to maintain oil pressure at low speeds. Additionally, an oil accumulator may be used to minimize the duration of operation of the auxiliary oil pump. Alternatively, the valves may be such that they are normally deactivated and require oil pressure to activate. Other types of valve activation and deactivation systems may be used, such as, but not limited to, a two-step roller finger follower, a sliding cam or electromagnetic valves. A variable lift valve control system may also be used to deactivate cylinders.

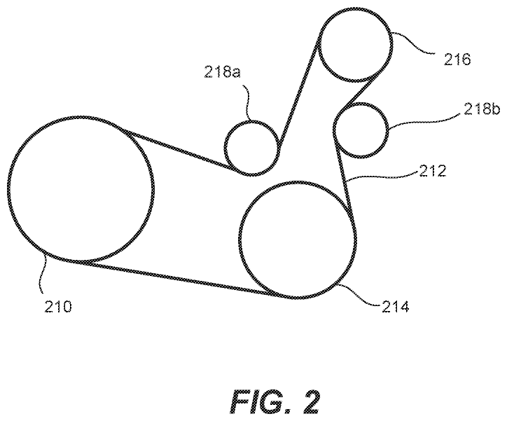

The motor/generator 302 replaces a conventional starter and can rapidly restart an engine that has been shut down due to implementation of a start/stop system. In the illustrated embodiment of FIG. 1, the motor/generator 302 is a crankshaft-integrated motor/generator. That is, the motor/generator 302 is connected to the crankshaft and positioned between the transmission 312 and the IC engine 304. Positioned between the engine 304 and the motor/generator 302 in the powertrain may be a vibration absorber 316. The vibration absorber 316 can take many forms such as, but not limited to, a dual mass flywheel, a spring mass vibration absorber, a variable spring absorber, and/or a centrifugal pendulum absorber. Various clutch elements, not shown in FIG. 1 may allow the motor/generator 302 to spin independent of the engine 304. The architecture depicted in FIG. 1 is commonly referred to as a P2 configuration; however, the present invention is not limited to this type of hybrid architecture. Any suitable motor/generator, such as a belt-alternator type motor/generator, may also be used. Such a belt driven system is schematically illustrated in FIG. 2.

A belt-driven motor/generator may be incorporated as part of a front-end accessory drive (FEAD) system as shown in FIG. 2. This hybrid architecture is commonly referred to as a PO architecture. A crankshaft 210 engages with a belt 212. The belt 212 in turn engages with an accessory drive 214, a motor/generator 216, and tensioners 218a and 218b. The belt 212 transfers torque between these rotating elements and the crankshaft 210. The accessory drive 214 may be used to power accessories, such as an air conditioner. The tensioners 218a and 218b may be spring loaded and take up slack in the belt 212, so that the belt 212 does not slip as it passes over the crankshaft 210, accessory drive 214, and motor/generator 216. The belt 212 must be tensioned so that the motor/generator 216 can both deliver and accept torque from the crankshaft 210. The crankshaft 210 may have one or more vibration absorbing elements such as a dual mass flywheel, a spring mass vibration absorber, a variable spring absorber, and/or a centrifugal pendulum absorber (not shown in FIG. 2). One problem with the hybrid architecture shown in FIG. 2 is that the belt 212 elasticity may result in undesirable torsional oscillation during restart. This can result in unacceptable NVH during the restart. In alternative embodiments, the belt 212 may be replaced by a chain or the accessories may be gear driven.

The tensioners 218a and 218b may each be mounted to a rigid surface, such as engine or part of the vehicle frame by a spring. The springs provides a tension on the belt 212, which helps to keep the belt from slipping on the crankshaft 210, accessory drive 214, and motor/generator 216. Alternatively, at least one of the tensioners 218a and 218b may be mounted to a rigid surface thru an affirmatively controlled mount mechanism that provides variable belt tension depending on the operating conditions. The variable belt tension may be applied by hydraulic, pneumatic, or electro-mechanical means. Use of an affirmatively controlled tensioner 218a or 218b may reduce the risk of excess stress on the belt 212, which may lead to belt premature failure.

Returning to FIG. 1, the motor/generator 302 is coupled with an energy storage system 308 via the power converter 307 and the crankshaft 310. The energy storage system 308 may include a battery, a capacitor, or a combination of a battery and capacitor operating in parallel. Advantageously, the system may operate at voltages less than 60 Volts, which allows use of less expensive electrical insulation. For example, the energy storage system may be a 48 V battery. The motor/generator 302 is arranged to discharge the energy storage system 308 and use the electrical power to apply torque to the powertrain when operated in a motoring mode. The motor/generator may be sized to provide a maximum steady-state power of 15 kW. While the average steady-state power may be limited to 15 kW, the instantaneous power may be 2× or 3× the average value. The power converter 307 converts the DC energy storage system output into a voltage output suitable for operating the motor/generator 302. This may be an AC or DC voltage depending on the type of electrical motor/generator used. In various embodiments, the power converter 307 may be a DC to DC converter, a power inverter, a power rectifier or other appropriate types of power converters. The applied torque rotates the engine and accelerates the engine speed to a desired level during an engine start phase. The motor/generator 302 is also arranged to subtract torque from the powertrain to charge the energy storage system 308 when operated in a generating mode by converting mechanical energy produced by the engine (or taken from the vehicle's kinetic energy) to electrical energy for charging the energy storage system 308. The power converter 307 facilitates conversion of the electricity supplied by the motor/generator 302 to the DC supply required by the energy storage system 308. The motor/generator 302 can rapidly switch from generating torque to absorbing torque and can rapidly vary the rate of torque generation/absorption. Depending on the type of electric motor/generator 302 and power converter 307, a transition from torque absorption to torque generation (and vice versa) can occur in 50 milliseconds, 10 milliseconds, 5 milliseconds, or 2 milliseconds or less. These fast switching times are faster than the switching times of currently commercially available power converters and motor/generator systems used for vehicle propulsion systems.

The electric motor/generator 302 can take many forms. For example, the electric motor/generator may be an internal permanent magnet brushless DC motor/generator, a surface permanent magnet brushless DC motor/generator, an AC induction motor/generator, an externally excited brushless DC motor/generator, a switched reluctance motor/generator or some other type of motor/generator. All the motor/generator types are very efficient at converting mechanical energy to electrical energy and vice versa. Conversion efficiencies are generally higher than 80%. Advantageously, the internal permanent magnet brushless DC motor provides very high efficiency operation, typically in the range of 92-95%. Another consideration in selection of an electric motor/generator is its operating speed range. Advantageously, a switch reluctance motor/generator can operate over a wider speed range than some of the other motor/generator types. This is particularly advantageous in the PO architecture where the engine and motor/generator rotate at the same speed.

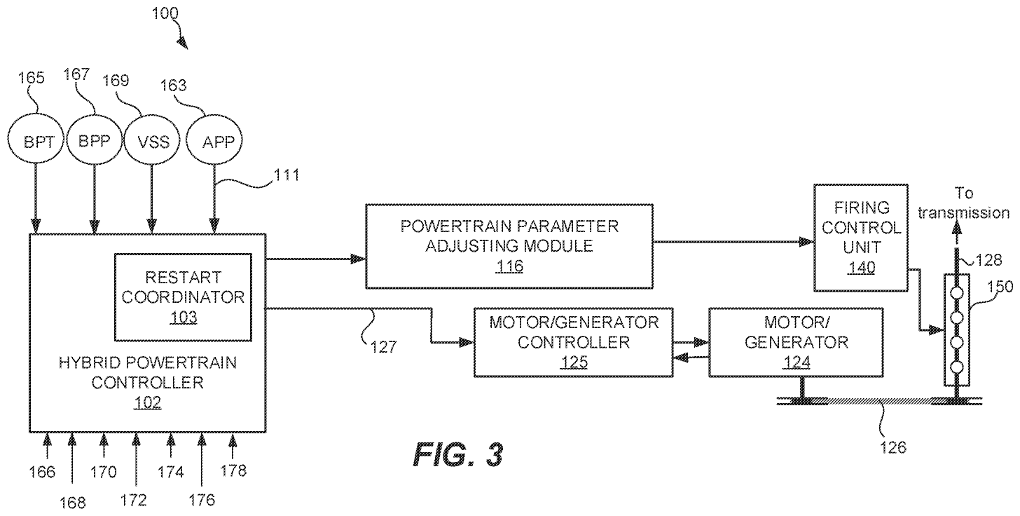

Referring to FIG. 3, an example hybrid powertrain system 100 that implements a start/stop feature will be described. The hybrid powertrain system includes a hybrid powertrain controller 102, a powertrain parameter adjusting module 116, a firing control unit 140, an electric motor/generator 124, an electric motor/generator controller 125, and an internal combustion engine 150. The internal combustion engine 150 drives crankshaft 128. The motor/generator 124 is mechanically connected to the crankshaft 128 via belt 126. The illustrated powertrain system 100 may additionally include features that allow the engine 150 to be operated in a skip-fire manner; however, such features are not required in some embodiments of the present invention and are described elsewhere.

The hybrid powertrain controller 102 is arranged to implement a start/stop feature for a hybrid powertrain during a drive cycle. The hybrid powertrain controller 102 determines whether the engine should be automatically shut down or restarted in accordance with the start/stop system. Such a shutdown generally occurs only under selected conditions e.g., when a vehicle has come to a complete stop, when a vehicle is at low speed (e.g. <5 km/hr) and a complete stop is anticipated, when ambient and engine temperature conditions are suitable, when the operator of the vehicle has pressed the brake pedal and released the accelerator pedal, etc. The engine start/stop management unit receives any inputs necessary to make the aforementioned shutdown determination. These inputs are derived from a variety of sources, including but not limited to a brake pedal travel (BPT) sensor 165, a brake pedal pressure (BPP) sensor 167, a vehicle speed sensor (VSS) 169, an accelerator pedal position (APP) 163 sensor, etc. The accelerator pedal position sensor 163 may generate a torque request signal 111 that is directed to the hybrid powertrain controller 102. Although not shown in FIG. 3, the torque request signal 111 may have additional processing or inputs other than those derived from the accelerator pedal position sensor 163, for example, an accessory torque demand.

In the illustrated embodiment, the hybrid powertrain controller 102 receives additional inputs indicating various operating parameters including, but not limited to, cam phase 166, timer 168, crankshaft angle 170, manifold absolute pressure (MAP) 172, barometric pressure 178, engine speed 176, coolant temperature and/or oil temperature 174. Based on these inputs, the hybrid powertrain controller 102 determines how the engine should be operated during restart. More specifically, the hybrid powertrain controller 102 is arranged to determine suitable conditions for stopping and restarting the engine. In some implementations, a restart coordinator 103 is included as part of the hybrid powertrain controller 102. The restart coordinator 103 may be connected to the motor/generator controller 125. The connection 127 may be by a CAN (Controller Area Network) bus, which is widely used in the automotive industry. The motor/generator controller 125 controls operation of the motor/generator 124. The motor/generator 124 may be mechanically connected by a belt 126 to a crankshaft 128. The restart coordinator 103 determines the engine torque fluctuations during restart and can control the motor/generator 124 to smooth these torque fluctuations, resulting in less net vibration of the crankshaft 128 and oscillatory motion of any elements, such as a vibration absorber mechanically connected to the crankshaft.

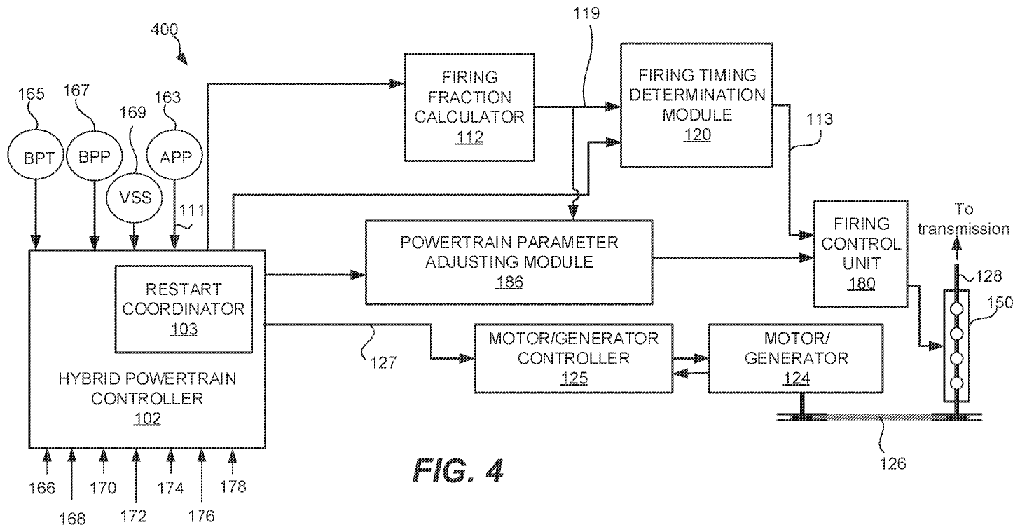

FIG. 4 shows an example hybrid powertrain system 400 that implements a start/stop feature that includes cylinder deactivation capability. The powertrain system 400 may have skip fire control capability such that a fire/no fire decision may be made on a firing decision by firing decision basis. Optionally the system 400 may include the ability to deactivate cylinders at low engine speeds. A deactivated cylinder has either or both its intake valve(s) or exhaust valve(s) closed throughout a working cycle so that substantially no air is pumped through the cylinder as the cylinder piston moves back and forth in the cylinder. In addition to the elements shown in FIG. 3 the system 400 includes a firing fraction calculator 112 and a firing time determination module 120. The firing control unit 180 and powertrain parameter adjusting module 186 have additional functionality compared to similar elements in FIG. 3, since they now control activation/deactivation of the intake and/or exhaust valves.

The torque request 111 is input into hybrid powertrain controller 202. Based on the torque request 111 the firing fraction calculator 112, power parameter adjusting module 186 and motor/generator controller 125 work in concert to determine operating conditions that provide the required torque. The firing fraction calculator 112 determines a skip fire firing fraction that would be appropriate to deliver the desired output under selected engine operations. The firing fraction is indicative of the fraction or percentage of firings under the current (or directed) operating conditions that are required to deliver the desired output. In some preferred embodiments, the firing fraction may be determined based on the percentage of optimized firings that are required to deliver the driver requested engine torque (e.g., when the cylinders are firing at an operating point substantially optimized for fuel efficiency). However, in other instances, different level reference firings, firings optimized for factors other than fuel efficiency, the current engine settings, etc. may be used in determining the appropriate firing fraction. The amount of the requested torque 111 supplied by the motor/generator 126 and engine 150 may be controlled to optimize fuel efficiency while providing acceptable NVH performance. In determination of overall fuel efficiency, the losses associated with generating energy in the engine, storing it, and then releasing the energy should be considered.

Once suitable firing fractions are generated, the firing fraction calculator transmits them as commanded firing fraction 119 to the firing timing determination module 120. The firing timing determination module 120 is arranged to issue a sequence of firing commands (e.g., drive pulse signal 113) that cause the engine 150 to deliver the percentage of firings dictated by a commanded firing fraction 119. In some implementations, for example, the firing timing determination module 120 generates a bit stream, in which each 0 indicates a skip and each 1 indicates a fire for the current cylinder firing opportunity.

Deactivation of a working chamber may be performed in a variety of ways. For example, a working chamber may be deactivated to form a low-pressure exhaust spring (LPES). In this case, air is not allowed through the intake valve and is not allowed to escape through the exhaust valve during a working cycle, which creates a vacuum within the working chamber. The deactivation of a working chamber may also involve a high-pressure exhaust spring (HPES). In this case, exhaust gases from firing a working chamber are not released in the subsequent exhaust stroke from the chamber i.e., the exhaust valve is not opened after the firing. A deactivated working chamber may in some cases operate as an air-spring (AS), where air initially at atmospheric pressure is trapped and expands and compresses as a piston moves within the cylinder.

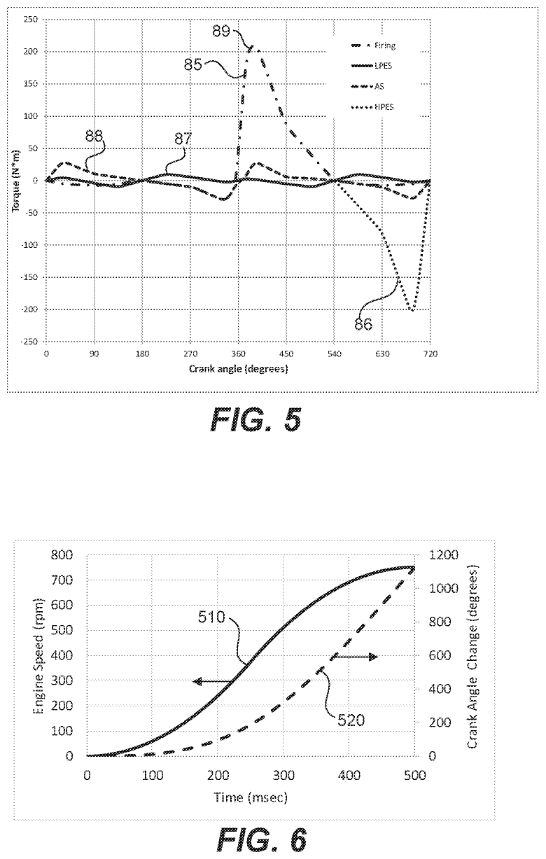

FIG. 5 illustrates representative torque profiles for different types of cylinder operation. In this figure, the horizontal axis is crank angle and the vertical axis is instantaneous torque. The 720 degrees of crank angle shown can be divided into 4 successive strokes, each stroke lasting for 180 degrees. The successive strokes are commonly denoted as intake, compression, power, and exhaust. A working chamber firing and venting on the exhaust stroke generates the “firing” curve 85. A working cycle having a combustion event, such as curve 85, has a large torque spike 89 associated with the combustion. If the fired cylinder is not vented, the exhaust stroke has the torque profile denoted as “HPES” in curve 86. If the cylinder is not fired and is closed off after an exhaust stroke the “LPES” curve 87 represents the torque profile. If the cylinder is not fired and the cylinder is closed off after an intake stroke, the “AS” curve 88 represents the torque profile. This advantageously reduces torque fluctuations induced by deactivated working chambers. Any of these working chamber torque profiles, as well as others not specifically mentioned here, may be used in the context of hybrid powertrain system 400.

The various torque profiles shown in FIG. 5 are representative only and will vary depending on the engine operating parameters. The torque spike magnitude and timing in the firing curve 85 will be impacted by the spark timing, as well as the air and fuel charge. While it is generally desirable to operate with a stoichiometric fuel to air ratio to avoid catalyst saturation, in some cases it may be desirable to operate a working chamber with a lean fuel to air ratio, to reduce the magnitude of the combustion associated torque spike. If the throttle is closed or substantially closed, the magnitude of the torque dip during the intake stroke will be larger due to the force required to draw air through the throttle. For cases where the engine is capable of deactivating one or more working chambers during the engine restart, the throttle may be left open or substantially open, for example, 80% or more open. This will result in the intake manifold remaining at or near, for example, within 80% of, atmospheric pressure.

During an engine stop, the hybrid powertrain controller 102 may operate the engine in a decel fuel cut off (DFCO) mode. In DFCO, fuel is cut off from the engine so no combustion and thus no net torque generation occurs. The engine will gradually slow to a stop due to frictional losses and the pumping of air through the engine. If the engine is capable of valve deactivation, a decel cylinder cut off (DCCO) mode may be used. In this case, no air is pumped through the cylinders and the engine slows to a stop due to frictional losses. Operating in DCCO is advantageous, since no oxygen is pumped through a catalytic converter in the exhaust system, so the oxidation/reduction balance in the catalyst is not altered. A further advantage of DCCO operation is that pumping losses are eliminated. Also, torque fluctuations on the crankshaft are lower in DCCO than DFCO resulting in smoother operation. In engines equipped with cam phase adjustment, the cam phaser may return to a phase angle appropriate for an engine restart. This phase angle may correspond to that which inducts a minimum amount of air into an activated cylinder. The hybrid powertrain controller 102 obtains information on the crankshaft rotation angle 170 of the stopped engine. For a four-stroke engine, typically used in automotive applications, the crankshaft rotation angle can vary between 0 and 720. Typically, the crankshaft rotation angle is measured in 6-degree increments. As well as the crankshaft rotation angle 170, the hybrid powertrain controller 102 may estimate an air charge that may be trapped in each cylinder. Information on the crankshaft rotation angle 170, cam phase (or more generally the intake and exhaust valve lift profile) 166, manifold absolute pressure 172, and temperature 174 may be used in determination of the air charge in each cylinder as the engine stops.

During the stop period, the MAP will drift toward atmospheric pressure, due to leakage of air past the throttle. Likewise, cylinder pressure will drift toward atmospheric pressure due to air leakage past the intake and exhaust valves and piston rings. The engine temperature will also cool due to lack of heat generating combustion. The hybrid powertrain controller 102 may track changes in the intake manifold pressure and cylinder air charge during the turned off period by using a model of air leakage into the intake manifold and cylinders. The air leakage model may utilize the timer input 168, which tracks a time the engine 150 has been stopped.

Referring initially to FIG. 3, an example hybrid powertrain system 100 that implements an engine restart feature will be described. The restart coordinator 103 may send information regarding the restart to the powertrain parameter adjusting module 116 and motor/generator controller 125. Attainable engine torque generation profiles will depend on the time the engine has been stopped and the stopped crankshaft rotation angle. Decisions on when and how much fuel to inject into each cylinder may be controlled to minimize torque perturbations during engine start up. Additionally, the motor/generator 124 may be used to add or subtract torque from the powertrain to mitigate or smooth torque variations that may be caused by the engine 150.

The restart coordinator 103 may determine a suitable restart trajectory which will help prevent unacceptable NVH during an engine restart. The restart trajectory generally quickly increase the engine speed, so that a driver experiences no perceivable delay in engine responsiveness, The restart trajectory may be dependent on the nature of the restart. For example, a restart may be triggered by a requirement to drive an accessory load, such as air conditioner. In such cases, the engine only needs to return to an idle speed. Such a restart trajectory may also be acceptable if the driver removes his/her foot from the brake pedal, but does not depress the accelerator pedal.

A representative restart trajectory 510 going to idle is shown in FIG. 6. In this example, the engine idle speed is 750 rpm and time desired time to reach idle speed is 0.5 seconds. The trajectory 510 depicts engine rotation speed in rpm (revolution per minute) versus time. The trajectory 510 shown in FIG. 6 is advantageous, since changes in the engine speed are gradual, minimizing the potential of inducing hammering of any powertrain vibration absorber. If the crankshaft moment of inertia is assumed to be 0.4 kg*m², a representative value for a 4-cylinder engine, then the maximum instantaneous power required to produce the trajectory 510 is approximately 25 kW. It is possible to produce this power level from a 15 kW steady-state power rated motor/generator. It should be appreciated that the trajectory 510 is idealized, and some higher frequency fluctuations in engine speed are acceptable.

Also shown in FIG. 6 is the change in engine crankshaft rotation angle 520 versus time. For the trajectory 510, the total change in engine crankshaft rotation angle is approximately 1140°. This corresponds to slightly more than three engine revolutions. A four-cylinder, four-stroke engine has six potential induction events and combustion events in three engine revolutions. Whether induction occurs depends on whether the cylinders can be deactivated and if deactivation is possible the deactivation strategy. If the cylinders cannot be deactivated, whether combustion occurs and what level of torque is produced depends on the powertrain parameters, particularly on whether the cylinder is fueled and the spark timing. If a combustion event occurs during the start-up period, the motor/generator may need to briefly switch from motoring (adding torque to the powertrain) to generating (absorbing torque from the powertrain). In this manner, the motor/generator can absorb some of a torque spike 89 associated with the combustion event, smoothing the restart trajectory 510. The motor/generator may transition from applying torque, to absorbing torque, to resuming torque application is less than 100 milliseconds.

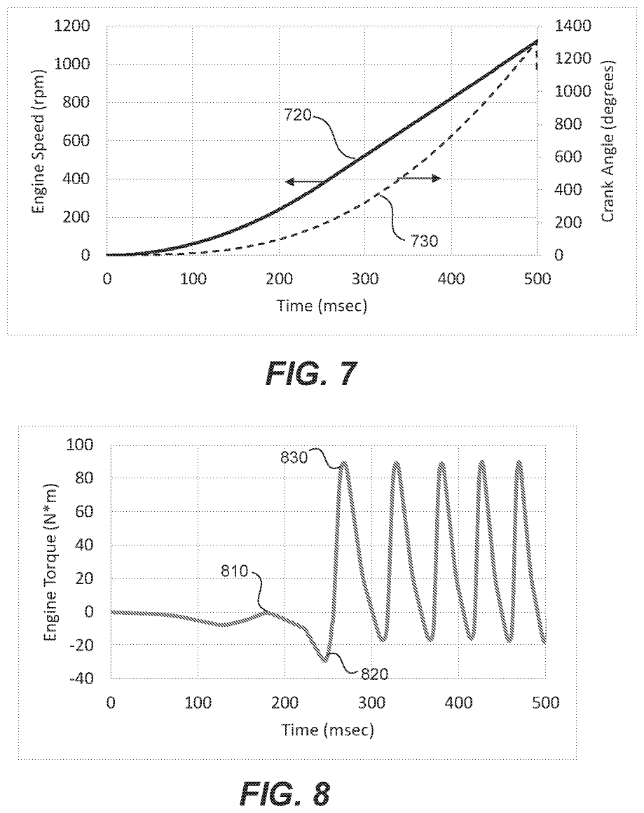

While some engine restarts may be designed to terminate at an engine idle speed, other engine restarts may have different termination criteria. For example, if a driver removes her/his foot from the brake pedal and moderately depresses or stomps on the accelerator pedal, a different restart trajectory may be used than the one depicted in FIG. 6. Such a restart may generally be referred to as an aggressive restart. FIG. 7 plot showing an exemplary engine speed trajectory 720 and crankshaft rotation angle 730 versus time during an aggressive engine restart. In this idealized restart trajectory, the first 250 milliseconds of the trajectory is identical to that shown in FIG. 6. However, in this case, the engine acceleration rate does not decrease after 250 milliseconds but continues at the same level thru the balance of the restart. As a result, after 0.5 seconds, the engine speed is significantly higher, more than 1100 rpm, as compared to an engine speed of 700 rpm depicted in the restart trajectory shown in FIG. 6. The engine restart for an aggressive restart may thus terminate at a higher crankshaft rotation speed than in a restart to idle.

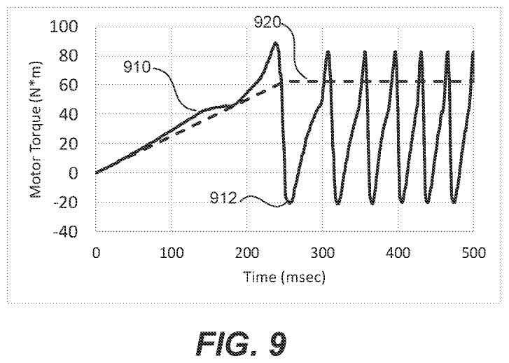

As previously, described some combination of torque produced by the internal combustion engine and torque generated, and possibly absorbed, by a motor/generator is used to accelerate the engine during a restart. FIG. 8 shows an exemplary engine torque profile 810 and FIG. 9 shows an exemplary electric motor/generator torque profile 910 for the restart trajectory shown in FIG. 7. In FIG. 8 the first two possible firing opportunities are skipped and then all subsequent firing opportunities are fired. The engine will generally have a negative torque spike 820 associated with the compression stroke of a cylinder prior to the cylinder firing. Firing a cylinder can produce a large torque spike 830 as shown in FIG. 8. The torque spikes 820 and 830 can result in unacceptable vibration during the restart. The torque spikes can be mitigated by applying a smoothing torque from the electric motor/generator. In some cases, such as that depicted in FIG. 9, the electric motor/generator may need to absorb, for example, at valley 912, rather than generate torque during the restart. In other cases, the engine torque may be sufficiently smoothed even though the electric motor/generator is always supplying torque to the powertrain. In this case, the electric motor/generator applied torque will oscillate, but always remain positive, during the restart. Also shown in FIG. 9 is the total torque 920 applied by both the engine and electric motor/generator to the powertrain. The total applied torque 920 can rise gradually and level off during the restart as depicted in FIG. 9. It should be appreciated that FIG. 9 shows an idealize representation of the total torque 920 and some torque oscillation will likely still be present in the total torque 920. The torque oscillation does not need to be totally cancelled, only reduced so that the NVH characteristics during the restart are acceptable.

Depending on the extent of accelerator pedal depression and possibly other factors, such as a temperature of an aftertreatment element, the sequence of firings and skips during the restart may be varied. Generally, greater depression of the accelerator pedal will result in firings occurring earlier and more frequently during the restart. If the temperature of the aftertreatment is below its operating range, the amount of uncombusted air pumped into the exhaust system may be minimized by deactivating cylinders during the restart.

The smooth start up engine speed trajectory depicted in FIGS. 6 and 7 may be achieved in a number of different ways depending on available engine controls. For engines without valve deactivation capability or where the valves cannot be deactivated at low engine speed, each cylinder working cycle pumps air through the engine into the exhaust system. Since pumping air through the exhaust system tends to saturate the catalyst with oxygen, it is desirable to fuel each working cycle to minimize any subsequent catalyst rebalancing. To maximize fuel efficiency, it is desirable to combust the fuel/air mixture to optimize torque generation. This may be achieved by initiating combustion using a spark timing that minimizes brake specific fuel consumption (bsfc).

Although it is generally desirable to maximize fuel efficiency, in some cases the spark timing may be adjusted to reduce torque output and change to torque profile of a fired cylinder. Depending on the air charge, injected fuel mass, and sparking timing a torque profile for each cylinder can be determined. These individual cylinder torque profiles can be summed, with the appropriate phasing, to determine an overall engine torque profile. Without torque mitigation from the motor/generator 124, the engine torque profile may induce hammering in a vibration absorber or some other undesirable NVH characteristics. By using the motor/generator 124 as a generator, some of the combustion related torque spike may be absorbed by the motor/generator reducing acceleration and/or other time derivatives of rotation speed on the vibration absorbing element and eliminating hammering.

For engines have valves that can be deactivated at low engine speeds, this capability can be used during engine restart. In this case, engine cylinders may be deactivated during start up. This avoids pumping any air through the catalyst and reduces torque fluctuations on the crankshaft. The motor/generator may supply all the torque required to increase the engine speed from a stop to idle. Even though no combustion is occurring, the engine may produce torque fluctuations from compression and/or expansion of trapped gases in the cylinder. Also, rotation of the camshaft generates a camshaft rotation angle dependent torque demand on the crankshaft. These fluctuations may be mitigated by the motor/generator 124 to avoid undesirable NVH. Once the engine reaches an appropriate speed, such as an engine idle speed, the intake and exhaust valves may be activated so that combustion may resume. The valve opening may be timed so that the valves begin to open at or near the beginning of an intake stroke of a cylinder. Not all cylinders need be activated and the engine can operate in a skip fire mode where some cylinders are activated and some remain deactivated. If the engine load is light, such as operation at idle, it is likely a low firing frequency can deliver the required torque to maintain engine speed. The torque spike associated with firing a cylinder may be absorbed or partially absorbed by the motor/generator to maintain an acceptable NVH level.

A cam phaser, that controls opening and closing timing of an intake valve, may be adjusted so that a minimum amount of air is inducted into the cylinder during each activated working cycle. This will help to reduce the magnitude of the torque spike associated with firing a cylinder. To improve fuel efficiency, a throttle, which controls air flow into an intake manifold, may be left open or nearly open to minimize pumping losses. Engines incapable of cylinder deactivation operating at idle or low engine loads require partially or completely closing the throttle to reduce air induction. In a skip fire controlled engine with a hybrid powertrain, idle and low load operation may be obtained using a low firing frequency to reduce air induction. The large and infrequent combustion generated torque spikes that occur in such operation produce a very uneven engine torque profile that may be smoothed in a hybrid powertrain by the motor/generator.

The engine speed trajectory 510 shown in FIG. 6 is not limiting and any smooth trajectory that does not result in unacceptable NVH may be used. In particular, any trajectory 510 that does not result in hammering of a vibration absorber in the powertrain may be acceptable. The trajectory 510 may be based on an NVH constraint in a manner that optimizes fuel efficiency. For example, if there are six firing opportunities in the transition from a stopped engine to idle speed, the torque profile of each combustion opportunity can be chosen to maximize fuel efficiency while yielding acceptable NVH characteristics.

It should be appreciated that the crankshaft angle position 520 shown in FIG. 6 starts at zero degrees, but this is not a limitation. In practice the engine may stop at any crank angle, which varies between 0 and 720 degrees for a 4-stroke engine. Depending on the initial position of the crankshaft angle at the beginning of the engine restart, the firing pattern may during restart may be different. For example, in a 4-cylinder engine there are 4 power strokes, each 180° in duration. The power strokes nominally start at crankshaft orientations of 0°, 180°, 360°, 540°. If the engine happens to stop at or near one of these orientations, the phasing of torque spikes resulting from firing cylinders will be different than if the engine stops at or near 90°, 700°, 450°, 630°. Thus, the firing sequence used to start the engine may differ depending on the initial crankshaft orientation at the beginning of the engine restart. Other factors, including but not limited to engine temperature, ambient temperature, engine lubricant temperature, and atmospheric pressure, may influence the restart firing sequence.

For skip-fire controlled engines, idle speed may be maintained using a low firing fraction and high MAP. This contrasts with conventional engine control where the engine is heavily throttled to limit air flow into the engine, causing inefficient engine operation. In skip fire operation, the throttle may be completely opened or substantially opened to reduce pumping losses, for example, the MAP may be within 20% of atmospheric pressure. The torque spike associated with combustion is at least partially cancelled by application of a smoothing torque from the electric motor/generator.

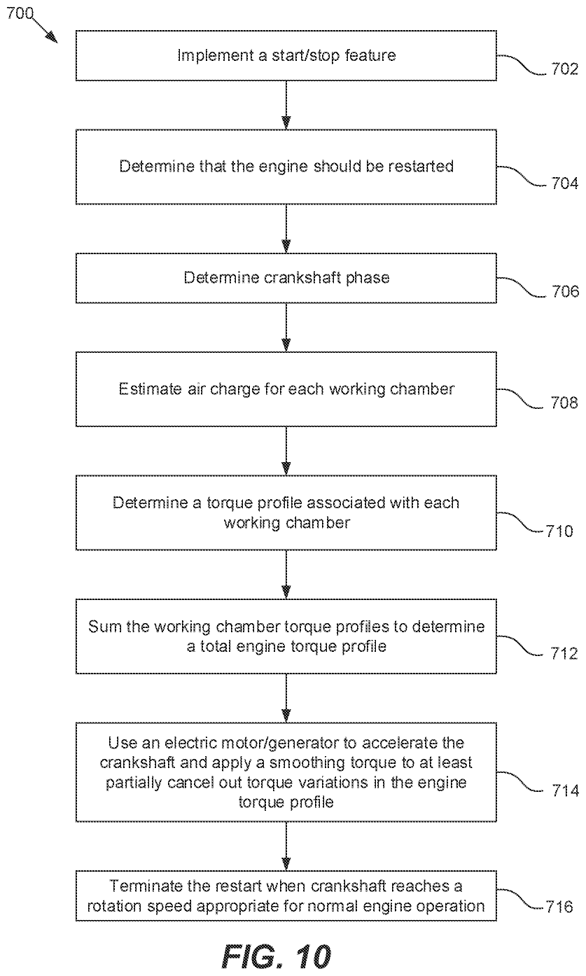

FIG. 10 is a flow chart 700 showing a method for implementing a stop/start system in a hybrid powertrain according to an embodiment of the present invention. Initially, at step 702, a start/stop feature is implemented. Generally, a start/stop feature involves shutting down an engine automatically during a vehicle drive cycle under selected conditions to conserve fuel. Any known start/stop-related technologies or techniques may be used when implementing the start/stop feature. After determining that the engine should be shut down in accordance with the start/stop feature, the hybrid powertrain controller then determines that the engine should be restarted (step 704). Any known techniques or conditions may be used to determine when a restart should occur. In various embodiments, for example, the restart is at least in part a response to the release of the brake pedal and/or the depression of the accelerator pedal.

As the engine is restarted at step 706 the crankshaft rotation angle is determined. Based on the crankshaft rotation angle and other variables, an air charge for each working chamber can be estimated in step 708. In step 710 the torque profile for each working chamber can be determined based at least in part on the air charge and other powertrain parameters. For skip fire controlled engines, information regarding whether the working chamber is deactivated is used in determination of the torque profile. In step 712 the individual torque profiles associated with all the engine's cylinders are summed, with the appropriate phasing, to yield a total engine torque profile. In step 714 an electric motor/generator is used to accelerate the engine and to apply a smoothing torque to at least partially cancel out torque variations in the engine torque profile. The engine restart is terminated in step 716 when the engine has reached an idle speed or some other speed appropriate for normal engine operation.

It should be appreciated that if a driver begins to depress the accelerator pedal prior to the engine reaching an idle speed, or the stop/start controller receives some other signal indicating an increase in the torque request, the engine speed trajectory may not level out as it approaches idle speed but may instead continue to increase to meet the torque demand. In skip fire controlled engines, the firing frequency can increase accordingly to meet the torque demand. In engines with a fixed displacement, the throttle can open to allow more air flow into the engine increasing torque output.

The previously described hybrid powertrain start/stop systems are not just applicable for a stopped vehicle. Engine stop and restart may occur while the vehicle is in motion. In such cases a restart may target an engine speed threshold synchronous to the driveline rotational speed at the current gear ratio and vehicle speed. Such a restart may be called a rolling engine restart and skip fire control may be used during the restart. The engine speed threshold, where at least one of the working chambers begins firing, is adjustable and need not be at the engine idle speed. Also in some cases the desired engine speed can be achieved while skipping at least one working chamber, i.e. the firing fraction after reaching the engine speed threshold may be less than one. During the entire sequence from stopping the engine to completing the engine restart, the vehicle remains in motion.

A further advantage of deactivating one or more cylinders on engine start-up is improved temperature stability of aftertreatment element(s) in an engine exhaust system. Modern internal combustion engines typically use one or more aftertreatment elements in the engine exhaust system to reduce emission of noxious pollutants, such as unburnt hydrocarbons, carbon monoxide, nitrous oxides, and soot. These aftertreatment elements generally require operation at an elevated temperature to be effective. By pumping uncombusted air thru an engine's cylinders during start-up, the aftertreatment element(s) are cooled, which depending on their starting temperature prior to engine restart, may make them less effective at removing noxious pollutants. In some embodiments, a different firing sequence may be used on engine start-up depending on the temperature of the aftertreatment element. The aftertreatment element temperature may be directly measured or may be inferred from other parameters, such as the length of time the engine was off.

The invention has been described primarily in the context of controlling the firing of 4-stroke piston engines suitable for use in motor vehicles. However, it should be appreciated that the described skip fire approaches are very well suited for use in a wide variety of internal combustion engines. These include engines for virtually any type of vehicle—including cars, trucks, boats, construction equipment, aircraft, motorcycles, scooters, etc.; and virtually any other application that involves the firing of working chambers and utilizes an internal combustion engine. The various described approaches work with engines that operate under a wide variety of different thermodynamic cycles—including virtually any type of two stroke piston engines, diesel engines, Otto cycle engines, Dual cycle engines, Miller cycle engines, Atkinson cycle engines, Wankel engines and other types of rotary engines, mixed cycle engines (such as dual Otto and diesel engines), radial engines, etc. It is also believed that the described approaches will work well with newly developed internal combustion engines regardless of whether they operate utilizing currently known, or later developed thermodynamic cycles.

In some preferred embodiments, where an engine is skip fire controlled, the firing timing determination module utilizes sigma delta conversion. Although it is believed that sigma delta converters are very well suited for use in this application, it should be appreciated that the converters may employ a wide variety of modulation schemes. For example, pulse width modulation, pulse height modulation, CDMA oriented modulation or other modulation schemes may be used to deliver the drive pulse signal. Some of the described embodiments utilize first order converters. However, in other embodiments higher order converters or a library of predetermined firing sequences may be used. In some embodiments with skip fire control, a decision whether to fire or skip any given firing opportunity may be made on a firing opportunity by firing opportunity basis. A firing decision may be determined at least in part using feed forward control, adaptive filter feed forward control, and/or feedback control from a signal related to the crankshaft rotation speed.

It should be appreciated that the engine/hybrid powertrain controller designs and configurations contemplated in this application are not limited to the specific arrangements shown in FIGS. 1 thru 4. One or more of the illustrated modules may be integrated together. Alternatively, the features of a particular module may instead be distributed among multiple modules. The controller may also include additional features, modules or operations based on other co-assigned patent applications, including U.S. Pat. Nos. 7,577,511; 7,849,835; 7,886,715; 7,954,474; 8,099,224; 8,131,445; 8,131,447; 8,616,181; 8,701,628; 8,880,258; 9,086,020; 9,120,478; 9,200,587; 9,239,037; 9,267,454; 9,273,643; 9,291,106; 9,328,672; 9,399,964; 9,512794; 9,650,971; 9,664,130; 9,945,313; 10,060,368 and 10,167,799; and U.S. patent application Ser. No. 15/918,284; each of which is incorporated herein by reference in its entirety for all purposes. Any of the features, modules and operations described in the above patent documents may be added to the illustrated hybrid powertrain systems 100, 300, and 400. In various alternative implementations, these functional blocks may be accomplished algorithmically using a microprocessor, ECU (engine control unit) or other computation device, using analog or digital components, using programmable logic, using combinations of the foregoing and/or in any other suitable manner. Various implementations include a hybrid powertrain controller, software or system arranged to perform some or all of the above operations.

In some applications referred to as multi-level skip fire engine operation, individual working cycles that are fired may be purposely operated at different cylinder outputs levels. Multi-level skip fire engine operation is described in detail in U.S. Pat. No. 9,399,964, which is incorporated herein by reference. In general, multi-level skip fire contemplates that individual working cycles of an engine may be selectively fired or skipped during individual cylinder working cycles and that fired working cycles may be purposely operated at different cylinder outputs levels in an interspersed manner. Cylinders are typically deactivated during skipped working cycles so that air is not pump through cylinders during the skipped cycles and there are a variety of different valve actuation management schemes that may be used to accomplish such deactivation.

The individual cylinder control concepts used in dynamic skip fire can also be applied to dynamic multi-charge level engine operation in which all cylinders are fired, but individual working cycles are purposely operated at different cylinder output levels. Skip fire, multi-level skip fire, and multi-charge level engine operation may collectively be considered different types of cylinder output level modulation engine operation in which the output of each working cycle (e.g., skip/fire, high/low, skip/high/low, etc.) is varied during operation of the engine. Sometimes the firing decisions are made dynamically on an individual cylinder working cycle by working cycle (firing opportunity by firing opportunity) basis or in small sets such as on an engine cycle by engine cycle basis.

When an engine/engine controller combination is capable of supporting multi-level skip fire operation with two distinct firing levels, there are a total of seven different basic operating modes that are possible. These include:
1. All-cylinder High Fire
2. All-cylinder Low Fire
3. High Fire+Skip
4. Low Fire+Skip
5. High Fire+Low Fire
6. High Fire+Low Fire+Skip
7. All Skips

Some engines/engine controllers will be capable of operating in all six of these modes. Some less full featured engines/engine controllers that still support multi-level firings may support only some of those operating modes. For example, some engines/cylinder output level modulation controllers support multiple firing levels but not skips. For example, such engines may only support All-Cylinder High Fire, All-Cylinder Low Fire, and High Fire+Low Fire operating modes. Others may add Low Fire+Skip and/or High Fire+Skip.

In some engines it is conceptually rather easy to support multi-level operation. For example, different output levels may be accomplished in many compression engines (e.g. diesel engines) by varying the fuel charge between different cylinders or cylinder working cycles. Engines that require stoichiometric air/fuel ratios (e.g., most gasoline engines) generally require the ability to vary the air charge in addition to varying the fuel charge in order to support multi-level operation. Engines having electronically actuated intake valves can theoretically vary the air charge on a cylinder firing opportunity by firing opportunity basis. However electronically actuated valves have not experienced much commercial success at this point.

Engines having cam actuated valves can support multi-level operations using a variety of different schemes. Some such schemes contemplate the use of multiple different cam lobes that can be readily switched between on an individual cylinder working cycle basis. In some embodiments, a first cam lobe is generally associated with an Otto cycle type working cycle, a second cam lobe is associated with a Miller or Atkinson cycle type working cycle that runs efficiently using lower air charges. In some implementations, a third cam lobe may be used for deactivated or skipped working cycles. Some implementations involve the use of two independently actuatable intake valves such that one, both or neither of the valves may be actuated for a given working cycle. Of course multi-level engine operation can be supported using a variety of other techniques so long as the output level of at least some of the cylinders can be controlled differently than other cylinders. A few such techniques are described in the referenced '964 patent.

When multi-level skip fire engine control is contemplated, the engine's state at any time can be characterized by a Firing Fraction (FF) and a High Fraction (HF). The Firing Fraction indicates the proportion of firing events (fired cylinder working cycles) out of a given total number of possible firing opportunities (total cylinder working cycles). The High Fraction indicates the proportion of High Firings events in a given period to the total number of firings (either high or low) that occur in that given period.

When the use of multiple non-zero firing levels is contemplated (e.g., during multi-level skip fire or multi-charge level operation of an engine), it is often helpful to consider an effective firing density (eFD) which correlates to the percentage or fraction of the cylinders that would be fired at a high or reference output. For example, if half of the cylinders are fired at a cylinder output level of 70% of a full firing output and the other half are fired at the full firing output level, then the effective firing density would be 85%. This corresponds to a Firing Fraction of 1.0 and a High Fraction of 0.5. If the “Low” cylinder output were reduced to 60% of a full firing, then the effective firing density would be reduced to 80% in this example.

In another example, if a quarter of the cylinders are fired at a cylinder output level of 70% of a full firing output, another quarter are fired at the full firing output level, and the other half are skipped, then the effective firing density would be 42.5%. This corresponds to a Firing Fraction of 0.5 and High Fraction on 0.5. In yet another example, if traditional skip fire operation is used (i.e., firing a designated percentage of the firing opportunities), then the effective firing density may represent the percentage of the cylinders that are actually fired. That is, the effective Firing Density is the same as the Firing Fraction.

The Applicant has previously described a variety of skip fire engine controllers and other cylinder output level modulation controllers including engine controllers that support multi-level skip fire operation. One cylinder output level modulation engine controller 10 suitable for implementing the inventions described herein is functionally illustrated in FIG. 1. Although a particular implementation is shown, it should be appreciated that the engine controller can be implemented in many other forms. The illustrated engine controller 10 includes a torque calculator 20, a firing density determining unit 30, a transition adjustment unit 40, a firing timing determination unit 50, a power train parameter adjusting module 60 and a firing controller 70. For the purposes of illustration, the described components are all shown as integral components of an engine control unit (ECU) 10 that is also capable of directing engine operation in a conventional, all cylinder operation manner. However, it should be appreciated that in other embodiments the functionalities of some or all of the identified components may be separated into a separate cylinder output level modulation controller.

Selected power train parameters are associated with specific effective firing density sequences. In some embodiments, each effective firing density sequence has an associated drive train slip that is used as the target drive train slip when the engine operates at the associated effective firing density sequence. In some embodiments, the target drive train slip for at least some of the firing fraction and high/low fraction combinations varies based at least in part on another power train parameter, as for example, engine speed.

The output of an engine is quickly changed at least in part by immediately changing an operational high/low fraction in response to a change in requested torque. In some instances, torque reductions are accomplished at least in part by reducing the high fraction to zero. In some embodiments, the operational high/low fraction is immediately reduced in response to a gear shift command or a traction control event. In other instances, commanded torque increases are accomplished at least in part by increasing the high fraction to one. In some instances, the operational firing fraction is immediately changed in parallel with the change in the operational high/low fraction.

Multi-level engine operation can be particularly useful during engine restarts. For example, when the torque requirement is relatively low, only low firings may be utilized (e.g., operation in the low fire and skip mode) as long as the low firings can deliver the requested torque, which helps mitigate the magnitude of the torque variations during engine starts/restarts. The smaller torque variations generally make it easier to mitigate torque variations using smoothing torque from an electric machine. As the requested torque increases, the density of low fires can be increased correspondingly. This can be particularly helpful during starts while the engine speed is low (e.g., below idle speed or below some other designated operational engine speed).

It should be appreciated that the aforementioned components and features may be integrated into a variety of hybrid powertrain architectures, including series hybrids, in which the engine is incapable of directly driving the wheels. The described techniques may also be applied to either mild hybrids or full hybrids. Mild hybrids involve hybrid powertrain systems in which the motor/generator is incapable of independently supplying sufficient power to the wheels to propel the vehicle, although such systems are capable of adding torque to the powertrain together with the engine. In a full hybrid, the motor/generator alone can be used to directly power the wheels.

While the invention has been described in terms of a driver controlled vehicle, it is also applicable to autonomously controlled vehicles. In this case the torque request signal 111 is generated by an autonomous control unit rather than a driver. The invention may also be applied to a cold start of an engine, that is engine start up at the beginning of a drive cycle.

What is claimed is:

1. A method for implementing a start/stop feature in a hybrid powertrain, the hybrid powertrain including an internal combustion engine and an electric motor, the engine having a crankshaft and a plurality of working chambers each having at least one associated intake valve, wherein the working chambers can be selectively deactivated during selected working chamber working cycles during operation of the engine, the method comprising:
i) automatically turning off the engine under selected circumstances during a drive cycle;
ii) determining that the turned off engine should be restarted during the drive cycle;
iii) using the electric motor/generator to rotationally accelerate the crankshaft to facilitate restarting the engine;
iv) restarting the engine with the at least one intake valve of at least one of the working chambers is controlled to cause introduction of a minimal air charge into such working chamber(s) during at least one activated working cycle of such working chamber(s) during the restart, each activated working cycle being fueled and fired.

2. A method as recited in claim 1 wherein the engine includes a variable valve lift control system that is used to deactivate the working chambers.

3. A method as recited in claim 1 wherein the engine includes at least one cam phaser that is used at least in part to control the air charges introduced into the working chambers in the active working cycles during the restart.

4. A method as recited in claim 1 wherein the electric motor/generator is directly connected to the crankshaft so that the electric motor/generator and the crankshaft rotate together at the same rotational speed.

5. A method as recited in claim 1 wherein the electric motor/generator is mechanically coupled to the crankshaft at least in part by one of a belt, a chain and a gear drive system so that the crankshaft and the electric motor/generator rotate together at a fixed ratio of rotational speeds.

6. A method as recited in claim 1 wherein the electric motor/generator is further configured to apply a smoothing torque to the crankshaft during the restart, wherein the smoothing torque is arranged to at least partially cancel out variations in an engine torque profile generated during the restart of the engine, thereby reducing NVH that would otherwise be generated by the engine during the restart.

7. A method as recited in claim 1 wherein the electric motor/generator is an integrated starter generator.

8. A method as recited in claim 1 wherein the electric motor/generator is a belt alternator starter.

9. A method as recited in claim 1 wherein the restart is completed when the crankshaft rotation speed reaches a designated level.

10. A method as recited in claim 1 wherein the engine is turned off and restarted multiple times during the drive cycle.

11. A method for operating a hybrid powertrain, the hybrid powertrain including an internal combustion engine and an electric motor, the engine having a crankshaft and a plurality of working chambers each having at least one associated intake valve, wherein the working chambers can be selectively deactivated during selected working chamber working cycles during operation of the engine, the method comprising:
i) deactivating all of the working chambers of the engine under selected circumstances while the crankshaft continues to rotate, thereby entering a DCCO operational mode;
ii) determining that the DCCO operational mode should be exited;
iv) as part of the DCCO exit, fueling and firing at least some active working chamber working cycles with the at least one intake valve of at least one of the working chambers controlled to cause introduction of a minimal air charge into such working chamber(s) during at least one of the active working cycles during the DCCO exit.

12. A method as recited in claim 11 wherein the engine includes a variable valve lift control system that is used to deactivate the working chambers.

13. A method as recited in claim 11 wherein the engine includes at least one cam phaser that is used at least in part to control the air charges introduced into the working chambers in the active working cycles during the restart.

14. A method as recited in claim 11 wherein the electric motor/generator is directly connected to the crankshaft so that the electric motor/generator and the crankshaft rotate together at the same rotational speed.

15. A method as recited in claim 11 wherein the electric motor/generator is mechanically coupled to the crankshaft at least in part by one of a belt, a chain and a gear drive system so that the crankshaft and the electric motor/generator rotate together at a fixed ratio of rotational speeds.

16. A method as recited in claim 11 wherein the electric motor/generator is further configured to apply a smoothing torque to the crankshaft during the restart, wherein the smoothing torque is arranged to at least partially cancel out variations in an engine torque profile generated during the restart of the engine, thereby reducing NVH that would otherwise be generated by the engine during the restart.

17. A method as recited in claim 11 wherein the electric motor/generator is an integrated starter generator.

18. A method as recited in claim 11 wherein the engine enters and exits the DCCO operational mode multiple times during a drive cycle.

19. A hybrid powertrain system for a vehicle, the hybrid powertrain system including an internal combustion engine having a plurality of working chambers connected to a crankshaft and an electric motor/generator, the hybrid powertrain system comprising:
a belt that mechanically connects the internal combustion engine to the electric motor/generator so that they rotate together;
a vibration absorber that rotates with the crankshaft; and
a restart coordinator that controls the internal combustion engine and the electric/motor generator during an engine restart using such that the electric motor/generator delivers a smoothing torque to the crankshaft that at least partially cancels a variation in torque generated by the engine during the engine restart, thereby reducing NVH that would otherwise be generated by the engine wherein the restart coordinator controls the internal combustion engine and electric motor/generator so that the crankshaft rotation trajectory during the engine restart is sufficiently smooth that it does not result in hammering of the vibration absorber in circumstances where hammering of the vibration absorber would otherwise occur during the restart absent the delivery of the smoothing torque.

20. A hybrid powertrain system as recited in claim 19 wherein the vibration absorber is selected from a group consisting of a dual mass flywheel, a variable spring absorber, a spring mass vibration absorber, and a centrifugal pendulum absorber.
